(19) United States
(12) Patent Application Publication
(10) Pub. No.: US 2006/0068124 A1
(43) Pub. Date: Mar. 30, 2006

(54) Method of making an adsorptive membrane

(76) Inventor: Cole Williams, Bainbridge Island, WA (US)

Correspondence Address: JAMES E. BRUNTON, ESQ., P. O. BOX 29000, GLENDALE, CA, 91209, US

(21) Appl. No.: 10/950,059

(22) Filed: Sep. 24, 2004

(51) Int. Cl. B29C 71/02

(52) U.S. Cl. 427/541

(57) ABSTRACT

A novel method of making an adsorptive membrane that incorporates super activated carbon particles in which the activated carbon particles that are incorporated within the membrane retain their highly adsorptive characteristics. In accordance with one form of the method of the invention, the multiplicity of small pores in the activated carbon particles are uniquely protected from becoming clogged during the process of forming the adsorptive membrane by initially wetting the particles with water prior to intermixing the particles with the hydrocarbon solvent solution of a polyurethane resin from which the membrane is formed.

### BACKGROUND OF THE INVENTION

1. Field of the Invention

The present invention relates generally to a method of making adsorptive membranes. More particularly, the invention concerns a method of incorporating super activated carbon particles within a thin polyurethane membrane material to form a highly adsorptive membrane.

2. Discussion of the Prior Art

Various attempts have been made in the past to make an adsorptive membrane that incorporates super activated carbon. Such attempts include mixing the carbon particles into a hydrocarbon solvent solution of a polyurethane resin and then casting or coating the mixture against a release paper. The coating is then dried to remove the solvent therefrom and to thereby form a thin membrane. However, in accordance with such prior art methods, the activated carbon undesirably retains some of the hydrocarbon solvent thereby substantially reducing the adsorptive properties of the activated carbon. It is this latter problem that the method of the present invention seeks to overcome.

### SUMMARY OF THE INVENTION

By way of summary, one form of the method of the present invention for making an adsorptive membrane that incorporates super activated carbon particles comprises the steps of first wetting the super activated carbon particles with water to provide a multiplicity of wetted particles; intermixing a polyurethane resin with a hydrocarbon solvent to form a resin solution; intermixing the wetted particles with the resin solution to form a carbon polyurethane resin mixture; depositing the carbon polyurethane resin mixture onto a substrate having a substantially planar surface to form a thin mass; and then heating the thin mass to an elevated temperature sufficient to remove the hydrocarbon solvent and the water therefrom to form an adsorptive membrane.

In view of the foregoing, it is an object of the present invention to provide a novel method of making an adsorptive membrane that incorporates super activated carbon particles in which the activated carbon particles that are incorporated within the membrane retain their highly adsorptive characteristics. More particularly, in accordance with one form of the method of the invention, the multiplicity of small pores in the activated carbon particles are uniquely protected from becoming clogged during the process of forming the adsorptive membrane.

### DESCRIPTION OF THE INVENTION

One form of the method of the present invention comprises the use of super activated carbon in the form of a granular powder. While such material is available from various sources, a material sold by Kansai Coke & Chemicals Company of Ohama-cho, Amagasaki-shi, Japan has proven to be well suited for use in making the adsorptive membrane of the present invention. This activated carbon exhibits a surface area of 3350 m² per gram with the median size of the particles of carbon being on the order of 78 microns. It is apparent that with this very large surface area, each granule of the material has millions of tiny gas adsorbing pores.

To prevent the undesirable dilution of the adsorptive qualities of the activated carbon by the hydrocarbon solvent solution clogging the pores of the material during the step of intermixing the activated carbon particles with the hydrocarbon solvent solution of a polyurethane resin, the method of the present invention uniquely involves the step of thoroughly wetting the super activated carbon with water prior to intermixing it with the polyurethane resin hydrocarbon solvent mixture. This novel step causes the millions of tiny pores of the material to fill with water thereby preventing the hydrocarbon solvent from filling the pores of the activated carbon during the intermixing of the wetted activated carbon with the polyurethane resin mixture. After intermixing the wetted activated carbon with the polyurethane resin solution, the mixture thus formed is controllably heated to drive off both the solvent and the water so as to once again open the pores in the activated carbon material to thereby substantially restore its adsorbing characteristics.

By way of example, in carrying out one form of the method of the present invention, the Kansai Coke & Chemicals Company super activated carbon granules are first thoroughly wetted with water to provide a multiplicity of wetted particles. Next, a readily commercially available polyurethane resin, such as that available from the Dow Chemical Co. of Midland, Mich. is intermixed with a suitable hydrocarbon solvent to form a resin solution. This done, the wetted particles are intermixed with the resin solution to form a carbon polyurethane resin mixture and the resin mixture thus formed is deposited onto a generally flexible substrate, such as a sheet of paper or the like having a substantially planar surface to form a thin mass. The thin mass is then heated by any suitable means to an elevated temperature sufficient to remove therefrom the hydrocarbon solvent and the water to form an adsorptive membrane.

Having now described the invention in detail, in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention, as set forth in the following claims.

I claim:

1. A method of making an adsorptive membrane that incorporates activated carbon particles comprising the steps of:
(a) wetting the activated carbon particles with water to provide a multiplicity of wetted particles;
(b) intermixing a polyurethane resin with a solvent to form a resin solution;
(c) intermixing said wetted particles with said resin solution to form a mixture;
(d) depositing said mixture onto a surface; and
(e) drying said mixture to remove the solvent and the liquid therefrom to form a membrane.

2. The method as defined in claim 1 in which said liquid comprises water.

3. The method as defined in claim 1 in which said mixture is heated to an elevated temperature sufficient to remove the hydrocarbon solvent and the liquid from said mixture.

4. The method as defined in claim 1 in which said surface comprises a sheet of paper.

5. A method of making an adsorptive membrane that incorporates activated carbon particles comprising the steps of:
(a) wetting the activated carbon particles with water to provide a multiplicity of wetted particles;
(b) intermixing a polyurethane resin with a hydrocarbon solvent to form a resin solution;
(c) intermixing said wetted particles with said resin solution to form a carbon polyurethane resin mixture;
(d) depositing said carbon polyurethane resin mixture onto a substrate having substantially planar surface to form a thin mass; and
(e) drying said thin mass to remove the hydrocarbon solvent and the water therefrom to form an adsorptive membrane.

6. The method as defined in claim 5 in which said mixture is heated to an elevated temperature sufficient to remove the hydrocarbon solvent and the water from said carbon polyurethane resin mixture.

7. The method as defined in claim 6 in which said substrate comprises a sheet of generally flexible material.

8. A method of making an adsorptive membrane that incorporates activated carbon particles comprising the steps of:
(a) wetting the activated carbon particles with water to provide a multiplicity of wetted particles;
(b) intermixing a polyurethane resin with a hydrocarbon solvent to form a resin solution;
(c) intermixing said wetted particles with said resin solution to form a carbon polyurethane resin mixture;
(d) depositing said carbon polyurethane resin mixture onto a substrate having a substantially planar surface to form a thin mass; and
(e) drying said thin mass to remove the hydrocarbon solvent and the water therefrom to form an adsorptive membrane.

9. The method as defined in claim 8 in which said mixture is heated to an elevated temperature sufficient to remove the hydrocarbon solvent and the water from said carbon polyurethane resin mixture.

10. The method as defined in claim 6 in which said substrate comprises a sheet of paper.

11. A method of making an adsorptive membrane that incorporates super activated carbon particles comprising the steps of:
(a) wetting the super activated carbon particles with water to provide a multiplicity of wetted particles;
(b) intermixing a polyurethane resin with a hydrocarbon solvent to form a resin solution;
(c) intermixing said wetted particles with said resin solution to form a carbon polyurethane resin mixture;
(d) depositing said carbon polyurethane resin mixture onto a substrate having a substantially planar surface to form a thin mass; and
(e) heating said thin mass to an elevated temperature sufficient to remove the hydrocarbon solvent and the water therefrom to form an adsorptive membrane.

12. The method as defined in claim 11 in which said substrate comprises a generally flexible material.

13. The method as defined in claim 12 in which said substrate comprises a sheet of paper.
